(19) United States
(12) Patent Application Publication
(10) Pub. No.: US 2026/0318520 A1
(43) Pub. Date: Oct. 15, 2026

(54) Light Emitting Component

(71) Applicant: Huizhou Victory Technology Ltd, Huizhou City (CN)

(72) Inventor: Guoyi Xie, Huizhou City (CN)

(73) Assignee: Huizhou Victory Technology Ltd, Huizhou City (CN)

(21) Appl. No.: 19/184,775

(22) Filed: Apr. 21, 2025

(30) Foreign Application Priority Data
Apr. 9, 2025 (CN) 202520660127.X

(51) Int. Cl. F21V 23/06; F21V 19/00; F21V 23/04; F21Y 101/00

(52) U.S. Cl. CPC F21V 23/06; F21V 19/0025; F21V 23/0421; F21Y 2101/00

(57) ABSTRACT

A light emitting component is provided, which includes battery components for providing electrical energy, a decorative lighting component for emitting light, and a connecting conductor for communicating circuits. Two ends of the decorative lighting component are respectively connected to positive and negative electrodes of the battery components. The decorative lighting component is communicated to the battery components through the connecting conductor, and there is a gap between the battery components. The connecting conductor is provided in the gap, and the connecting conductor can slide in the gap between the battery components. The design of the present disclosure controls the connection or disconnection of the overall circuit by sliding the connecting conductor, thereby controlling the decorative lighting components to turn on or off. This compact and simple structure can effectively reduce production costs.

### CROSS-REFERENCE TO RELATED APPLICATIONS

This application claims priority to Chinese Patent Application No. 202520660127.X, filed on Apr. 9, 2025, which is hereby incorporated by reference in its entirety.

### TECHNICAL FIELD

The present disclosure relates to the field of light emitting components technologies, and in particular, to a light emitting component.

### BACKGROUND

When handicrafts, toys, or other electronic products are used, lighting fixtures are usually arranged to enhance their ornamental or playability. CN202221641358.9, entitled with a battery component for a luminous toy discloses that the sealing plate drives the connecting plate through two sets of sliding rods, and the connecting plate drives two sets of L-shaped plates to move along the guide column towards the installation groove. The L-shaped plate compresses the spring, and at the same time, the sealing plate drives the socket to move towards the installation groove until the sealing plate is in contact with the installation plate and the quick plug male head is facing the quick plug female head. At this time, the sealing plate is pushed and drives the two sets of sliding rods to slide along the through holes on the connecting plate, so that the sealing plate drives the docking column to insert into the quick plug female head through the socket, and the sealing plate is inserted into the limit frame. The sealing plate is limited by the limit bracket, and a docking between the quick plug female head and the quick plug male head is achieved.

However, the above-mentioned technical solution has a complex structure and high production costs. Besides that, the light emitting components in the existing technology are prone to accidentally touch the switch during transportation, which can pose safety hazards or cause the battery to be depleted during transportation. Therefore, a new technical design with a simple structure is needed to solve the above problems.

### SUMMARY

The purpose of the present disclosure is to provide a light emitting component to solve problems of high production cost and easy accidental contact of switches during transportation or use in the background technology mentioned above.

The present disclosure provides the following technical solution: a light emitting component, including battery components configured to provide electrical energy, a decorative lighting component configured to emit light, and a connecting conductor configured to communicate circuits; two ends of the decorative lighting component are respectively connected to positive and negative electrodes of the battery components, and the decorative lighting component is communicated to the battery components through the connecting conductor; there is a gap between the battery components, and the connecting conductor is provided in the gap, the connecting conductor is capable of sliding in the gap between the battery components.

In some embodiments of the present disclosure, the battery components include a battery box and a battery that are matched with each other, the battery is provided in the battery box, there are at least two battery boxes, and the gap is provided between the battery boxes.

In some embodiments of the present disclosure, contact slots are provided on inner side walls of adjacent two battery boxes, and the contact slots and the connecting conductor are matched with each other; after sliding into the contact slots, the connecting conductor enables the decorative lighting component to communicate with the battery components through the connecting conductor.

In some embodiments of the present disclosure, the inner side walls of adjacent two battery boxes are provided with limiting parts, and the limiting parts are configured to prevent the connecting conductor from communicating to the battery components without human operation, and the limiting parts and the connecting conductor are matched.

In some embodiments of the present disclosure, the connecting conductor includes a sliding part and a conductive contact end, the sliding part and the conductive contact end are fixedly connected, the sliding part drives the conductive contact end to slide within the gap between the battery components, and the decorative lighting component is communicated to the battery components through the conductive contact end.

In some embodiments of the present disclosure, the conductive contact end includes an electric shock end and an extension end, the electric shock end and the extension end are fixedly connected or integrally formed, the extension end is fixedly connected to the sliding part.

In some embodiments of the present disclosure, one end of the extension end that is connected to the sliding part is a horizontal connection or a bent arch connection.

In some embodiments of the present disclosure, the electric shock end is a circular arc shape, a spherical shape, or a hemispherical convex shape.

In some embodiments of the present disclosure, there are two symmetrical electric shock ends, and the two electric shock ends are fixedly connected or integrally formed.

In some embodiments of the present disclosure, the electric shock end and the extension end are both made of steel or iron.

In some embodiments of the present disclosure, the decorative lighting component includes a lamp bead, a lamp bead positive electrode pin line, and a lamp bead negative electrode pin line, the lamp bead is connected to positive and negative electrodes of the battery components through the lamp bead positive electrode pin line and the lamp bead negative electrode pin line.

In some embodiments of the present disclosure, a positive electrode connection port and a negative electrode connection port are provided on the battery components configured to connect the lamp bead positive electrode pin line and the lamp bead negative electrode pin line, where the lamp bead positive electrode pin line is connected to the positive electrode of the battery components through the positive electrode connection port, and the lamp bead negative electrode pin line is connected to the negative electrode of the battery components through the negative electrode connection port.

In some embodiments of the present disclosure, bottoms of the battery components are provided with bottom covers, the bottom covers are clamping connected or threaded connected to the battery boxes.

Compared with existing technology, the beneficial effects of the present disclosure are as follows.

The light emitting component of the present disclosure includes battery components for providing electrical energy, a decorative lighting component for emitting light, and a connecting conductor for connecting circuits. The two ends of the decorative lighting component are connected to the positive and negative electrodes of the battery components. The decorative lighting component is communicated to the battery components through the connecting conductor, and there is a gap between the battery components. The connecting conductor is provided in the gap, and the connecting conductor can slide in the gap between the battery components. The connection or disconnection of the overall circuit is controlled by sliding the connecting conductor in the gap between the battery components, thereby controlling illumination or extinguishing of the decorative lighting component. This compact and simple structure can effectively reduce production costs.

In the light emitting component of the present disclosure, the batter components include a battery box and a battery that are matched with each other. The battery is provided inside the battery box, and there are at least two battery boxes. The gap is provided between the battery boxes. The connecting conductor is provided in the gap, which can effectively control whether the connecting conductor is in contact with the battery, thereby effectively controlling illumination or extinguishing of the decorative lighting component, and it is easy to operate.

The light emitting component of the present disclosure is provided with contact slots on the inner side walls of adjacent battery boxes. The contact slots match with the connecting conductor, and the connecting conductor is slid into the contact slots to enable the decorative lighting component to communicate with the battery components through the connecting conductor. The connecting conductor is communicated to the battery through the contact slots, the circuit is communicated, and the decorative lighting component will emit light.

The light emitting component of the present disclosure is provided with limiting parts on the inner side walls of two adjacent battery boxes, and the limiting parts are configured to prevent the connecting conductor from communicating to the battery components without human operation. The limiting parts are matched with the connecting conductor. Providing the limiting parts effectively prevents the connecting conductor from sliding to the contact slots during transportation or subjected by external impact when the connecting conductor is not placed at the contact slots; or when the connecting conductor is placed at the contact slots, it may cause the connecting conductor to slide out of the contact slots; providing the limit part will make a sound when the connecting conductor is slid, rendering it easy to use or determine whether the connecting conductor has slid to the position.

The light emitting component of the present disclosure includes a sliding part and a conductive contact end. The sliding part and the conductive contact end are fixedly connected, and the sliding part drives the conductive contact end to slide in the gap between the battery components. The decorative lighting component is communicated to the battery components through the conductive contact end. When the sliding part slides forward, it drives the conductive contact end to slide to the contact slots, and the conductive contact end is communicated to the battery, thereby forming a circuit, and the decorative lighting component begins to emit light. When the sliding part slides backwards, it drives the conductive contact end to slide out of the contact slots, the overall circuit is disconnected, and the decorative lighting component is turned off.

In the light emitting component of the present disclosure, the conductive contact end has an electric shock end and an extension end. The electric shock end and the extension end are fixedly connected or integrally formed, and the extension end is fixedly connected to the sliding part. When the sliding part slides forward, it drives the electric shock end to slide to the contact slots, and the electric shock end is communicated to the battery, thereby forming a circuit, and the decorative lighting component begins to emit light. When the sliding part slides backwards, it drives the electric shock end to slide out of the contact slots, the overall circuit disconnects, and the decorative lighting component is turned off.

In the light emitting component of the present disclosure, the end where the extension end is connected to the sliding part is a horizontal connection or a bent arch connection. When the extension end is horizontally connected to the sliding part, it will be more effortless to slide the sliding part. When the end connecting the extension end and the sliding part is a bent arch connection, the assembly of the connection between the extension end and the sliding part will be more convenient.

In the light emitting component of the present disclosure, the shape of the electric shock end is a circular arc shape, a spherical shape, or a hemispherical convex shape. The setting of circular arc shape, spherical shape or hemispherical convex shape of the electric shock end enables better contact and connection with the battery, and the limiting part can better limit the contact end.

In the light emitting component of the present disclosure, there are two symmetrical electric shock ends, the electric shock ends are fixedly connected or integrally formed. The two electric shock ends are symmetrically arranged to better communicate with the battery and render the circuit more stable.

In the light emitting component of the present disclosure, the electric shock end and the extension end are both made of steel or iron. The selection of materials ensures excellent conductivity.

In the light emitting component of the present disclosure, the decorative lighting component includes a lamp bead, a lamp bead positive electrode pin line, and a lamp bead negative electrode pin line. The lamp bead is connected to the positive and negative electrodes of the battery components through the lamp bead positive electrode pin line and the lamp bead negative electrode pin line. Through this setting, the lamp bead is more stably connected to the battery through the lamp bead connection wire, and the circuit is more stable.

In the light emitting component of the present disclosure, a positive connection port and a negative connection port are provided on the battery components for connecting the lamp bead positive electrode pin line and the lamp bead negative electrode pin line. The lamp bead positive electrode pin line is communicated to the positive electrode of the battery components through the positive connection port, and the lamp bead negative electrode pin line is connected to the negative electrode of the battery components through the negative connection port. The positive connection port and the negative connection port make the connection between the decorative lighting component and the battery components more stable, the circuit more stable, and less prone to disconnection.

In the light emitting component of the present disclosure, the bottom covers are provided at the bottoms of the battery components, and the bottom covers are clamping connected or threaded connected to the battery components. The setting of the bottom covers effectively prevents the battery from falling off.

### BRIEF DESCRIPTION OF DRAWINGS

In order to provide a clearer explanation of the embodiments or technical solutions in the present application or existing technology, a brief introduction will be given to the accompanying drawings required for the embodiments or existing technology description. It is obvious that the accompanying drawings described below are only some embodiments of the present application. For those skilled in the art, other drawings can be obtained based on these drawings without requiring creative work.

FIG. 1 is a three-dimensional schematic diagram of a light emitting component of the present disclosure.

FIG. 2 is an exploded view of the light emitting component of the present disclosure.

FIG. 3 is a front view of the light emitting component of the present disclosure.

FIG. 4 is a schematic diagram of the light emitting component is power on of the present disclosure.

FIG. 5 is a schematic diagram of the light emitting component is power off of the present disclosure.

FIG. 6 is a bottom view of a driving component of the light emitting component of the present disclosure.

FIG. 7 is a bottom view of the driving component of the light emitting component of the present disclosure.

### NUMERAL REFERENCE

1—battery component; 11—battery box; 111—contact slot; 112—limiting part; 2—decorative lighting component; 21—lamp bead; 22—lamp bead positive electrode pin line; 23—lamp bead negative electrode pin line; 3—connecting conductor; 31—sliding part; 32—conductive contact end; 321—electric shock end; 322—extension end; 4—bottom cover; 5—gap; 6—positive electrode connection port; 7—negative electrode connection port.

### DESCRIPTION OF EMBODIMENTS

The following provides a detailed description of the embodiments of the present application, examples of which are shown in the accompanying drawings, where the same or similar reference numerals from beginning to end represent the same or similar elements or elements with the same or similar functions. The embodiments described below with reference to the accompanying drawings are exemplary and are only used to explain the present application, and should not be construed as limiting the present application.

In the description of this application, terms “first” and “second” are only used for a descriptive purpose and cannot be understood as indicating or implying relative importance or implying the number of technical features indicated. Thus, the features limited to “first” and “second” may explicitly or implicitly include one or more of the aforementioned features. In the description of this application, the meaning of “multiple” refers to two or more, unless otherwise specifically limited.

In the description of this application, it should be noted that unless otherwise specified and limited, terms “installation” and “connection” should be broadly understood, for example, it can be a fixed connection, a detachable connection, or an integrated connection; it can be a mechanical connection, an electrical connection, or communication with each other; it can be directly connected or indirectly connected through an intermediate medium, and it can be a connection within two components or an interaction relationship between two components. For those skilled in the art, specific meanings of the above terms in this application can be understood according to the specific situation.

In the description of this application, it should be understood that terms “up”, “down”, “side”, “front”, “back”, etc. indicate orientation or position relationships based on installation, only for the convenience of describing this application and simplifying the description, and do not indicate or imply that the device or component referred to must have a specific orientation, be constructed and operated in a specific orientation, and therefore cannot be understood as a limitation of this application.

In the description of this application, it should be noted that term “and/or” is only a description of the association relationship between related objects, indicating that there can be three types of relationships, such as A and/or B, which can represent: the existence of A alone, the existence of A and B at the same time, and the existence of B alone.

It should be noted that in the embodiments of the present application, the same reference numerals are used to represent the same components or parts. For the same parts in the embodiments of the present application, only one part or component may be marked with a reference numeral in the figure. It should be understood that for other identical parts or components, the reference numerals are also applicable.

Besides that, in this application, the technical features described in an open manner include both closed technical solutions containing the listed features and open technical solutions containing the listed features.

In order to further understand the content, characteristics, and efficacy of the present disclosure of the present application, the following embodiments are listed and explained in detail with the accompanying drawings:

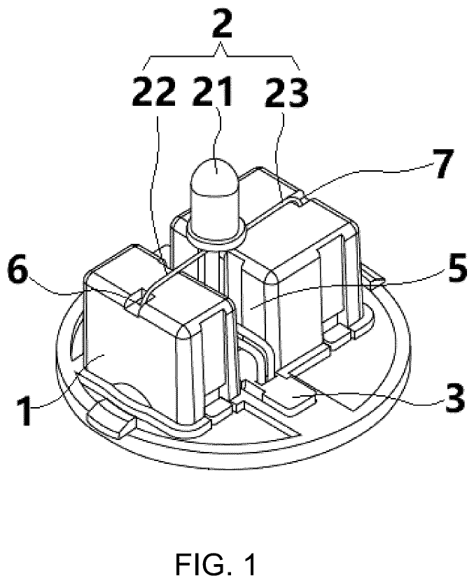

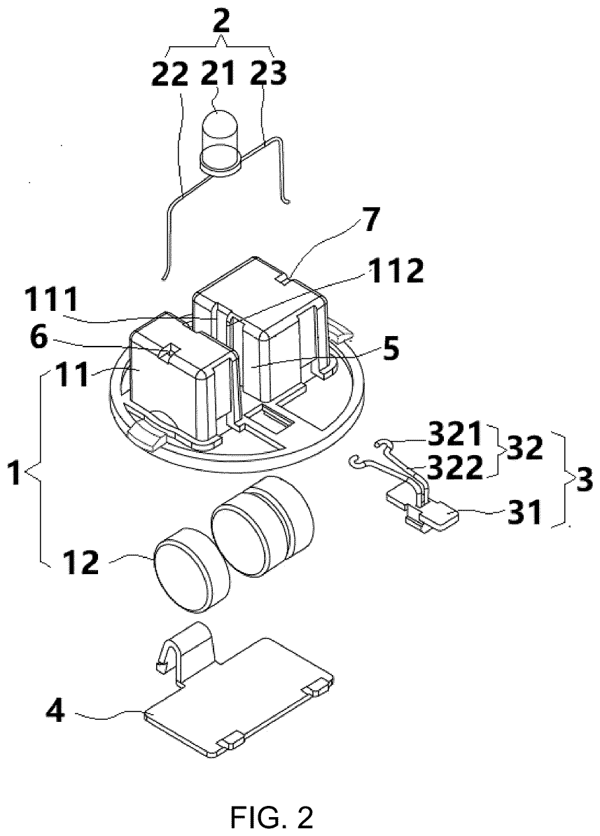

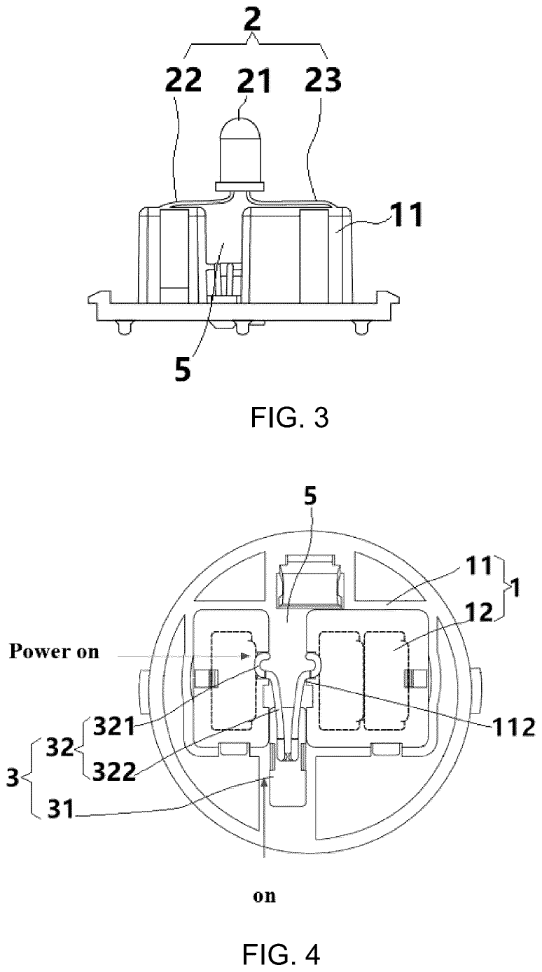

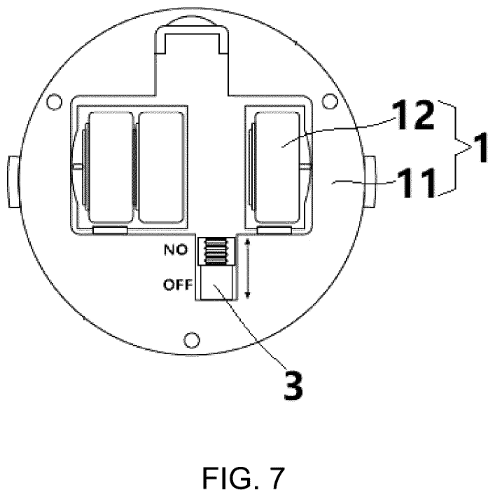

As shown in FIGS. 1-7, a light emitting component includes battery components 1 for providing electrical energy, a decorative lighting component 2 for emitting light, and a connecting conductor 3 for connecting the circuit. Two ends of the decorative lighting component 2 are respectively connected to positive and negative electrodes of the battery components 1. The decorative lighting component 2 is communicated to the battery components 1 through the connecting conductor 3, and there is a gap 5 between the battery components 1. The connecting conductor 3 is provided in the gap 5, and the connecting conductor 3 can slide in the gap 5 between the battery components 1. In this embodiment, the connection or disconnection of the overall circuit is controlled by sliding the connecting conductor within the gap, thereby controlling the lighting or extinguishing of the decorative lighting component. When the connecting conductor moves to the battery, the circuit is connected, and the decorative lighting component emits light. When the connecting conductor is moved out and is not contact with the battery, the circuit is disconnected, and the decorative lighting component is turned off. This structure is compact and simple, which can effectively reduce production costs. Of course, the above structure is not limited to this and can be any other structure that serves the same purpose.

In an implementation mode, as shown in FIGS. 1 and 4-7, the battery components 1 include a battery box 11 and a battery 12 that match each other. The battery 12 is located inside battery box 11, there are at least two battery boxes 11. The gap 5 is provided between battery boxes 11. In this embodiment, there are at least two battery boxes, and one to two batteries can be placed inside each battery box. The connecting conductor is provided in the gap, which can effectively control whether the connecting conductor is in contact with the battery and whether the decorative lighting component is turned on or off. The operation is simple. Of course, it is not limited to this, and other methods can be used to cause the connecting conductor to slide between the light emitting component.

In an implementation mode, as shown in FIG. 4, contact slots 111 are provided on inner side walls of adjacent battery boxes 11. The contact slots 111 match the connecting conductor 3, and the connecting conductor 3 slides into the contact slots 111 to enable the decorative lighting component 2 to communicate with the battery components 1 through the connecting conductor 3. In this embodiment, by setting the contact slots, when the connecting conductor slides to the position of the contact slots, it can effectively contact and communicate with the battery, and the decorative lighting component will emit light. When the connecting conductor slides out of the contact slots, the connecting conductor and the battery are disconnected, the circuit is disconnected, and the decorative lighting component will turn off. Of course, the above structure is not limited to this, and other structures that can communicate the connecting conductor and the battery can be used.

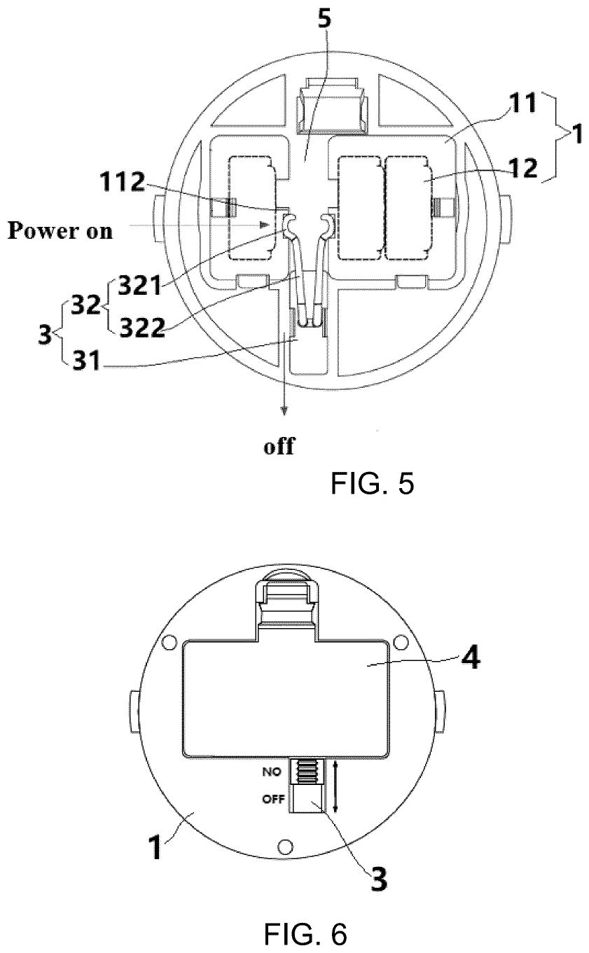

In an implementation mode, as shown in FIGS. 4-5, limiting parts 112 are provided on the inner side walls of adjacent two battery boxes 11. The limiting parts 112 are configured to prevent the connecting conductor 3 from communicating to the battery components 1 without human operation. The limiting parts 112 match the connecting conductor 3. In this embodiment, the setting of the limiting parts effectively prevents the connecting conductor from sliding to the contact slots during transportation or subjected by external impact when the connecting conductor is outside the contact slots; or when the connecting conductor is placed at the contact slots, it may cause the connecting conductor to slide outside the contact slots, and the setting of the limiting parts will make a sound when the connecting conductor slides, which is convenient for a use or to distinguish whether the connecting conductor has slid to the position. Of course, the above structure is not limited to this, and it can be other structures that limit the connecting conductor and make sound when the connecting conductor is sliding.

In an implementation mode, the connecting conductor 3 includes a sliding part 31 and a conductive contact end 32. The sliding part 31 and the conductive contact end 32 are fixedly connected, and the sliding part 31 drives the conductive contact end 32 to slide within the gap 5 between the battery components 1. The decorative lighting component 2 is communicated to the battery components 1 through the conductive contact end 32. In this embodiment, when the sliding part slides forward, it drives the conductive contact end to slide to the contact slots, and the conductive contact end is communicated to the battery, thereby forming a circuit, and the decorative lighting component begins to emit light. When the sliding part slides backwards, it drives the conductive contact end to slide out of the contact slots, the overall circuit is disconnected, and the decorative lighting component is turned off. Of course, the above structure is not limited to this and can be any other structure that serves the same purpose.

In an implementation mode, the conductive contact end 32 includes an electric shock end 321 and an extension end 322. The electric shock end 321 and the extension end 322 are fixedly connected or integrally formed, and the extension end 322 is fixedly connected to the sliding part 31. In this embodiment, when the sliding part slides forward, it drives the electric shock end to slide to the contact slots, and the electric shock end is communicated to the battery, thereby forming a circuit, and the decorative lighting component begins to emit light. When the sliding part slides backwards, it drives the electric shock end to slide out of the contact slots, the overall circuit disconnects, and the decorative lighting component is turned off. Of course, the above structure is not limited to this and can be any other structure that serves the same purpose.

In an implementation mode, one end the extension end 322 that is connected to the sliding part 31 is a horizontal connection or a bent arch connection. In this embodiment, when the end connecting the extension end and the sliding part is horizontally connected, it will be more effortless to slide the sliding part. When the end connecting the extension end and the sliding part is a bent arch connection, the assembly of the connection between the extension end and the sliding part will be more convenient. Of course, the above structure is not limited to this and can be other structures or shapes that serve the same purpose.

In an implementation mode, the electric shock end 321 is a circular arc shape, a spherical shape, or a hemispherical convex shape. In this embodiment, there are two symmetrical electric shock ends, the electric shock end is a circular arc shape, spherical shape, or hemispherical convex shape, so that it can better contact and communicate with the battery, and the limiting parts can better limit the contact end. Of course, the above is not limited to this. The shape of the electric shock end can be other structures or shapes that can be connected to the battery and limited by the limiting parts.

In an implementation mode, the electric shock end 321 and the extension end 322 are both made of steel or iron. In this embodiment, when the electric shock end and the extension end are integrally formed, the materials of the electric shock end and the extension end are both steel or iron. The selection of materials ensures excellent conductivity. When the electric shock end and the extension end are fixedly connected, the extension end can be made of non-metallic material. Of course, the above is not limited to this and can also be other materials that have a conductive effect.

In an implementation mode, there are two symmetrical electric shock ends 321, and the two electric shock ends 321 are fixedly connected or integrally formed. In this embodiment, the two electric shock terminals are symmetrically arranged to better communicate with the battery and make the circuit more stable. Of course, the above is not limited to this and can also be other materials that have a conductive effect.

In an implementation mode, the decorative lighting component 2 includes a lamp bead 21, a lamp bead positive electrode pin line 22, and a lamp bead negative electrode pin line 23. The lamp bead 21 is connected to positive and negative electrodes of the battery components 1 through the lamp bead positive electrode pin line 22 and the lamp bead negative electrode pin line 23. In this embodiment, through this setting, the lamp beads are more stably connected to the battery through the lamp bead positive electrode pin line and the lamp bead negative electrode pin line, and the circuit is more stable. Of course, it is not limited to this, and other structures can be used to ensure a stable connection between the lamp beads and the battery.

In an implementation mode, a positive electrode connection port 6 and a negative electrode connection port 7 are provided on the battery components 1 for connecting the lamp bead positive electrode pin line 22 and the lamp bead negative electrode pin line 23. The lamp bead positive electrode pin line 22 is connected to the positive electrode of the battery components 1 through the positive electrode connection port 6, and the lamp bead negative electrode pin line 23 is connected to the negative electrode of the battery components 1 through the negative electrode connection port 7. In this embodiment, the positive connection port and negative connection port make the connection between the decorative lighting component and the battery components more stable, the circuit more stable, and less prone to disconnection. Of course, it is not limited to this, and other structures can be used to ensure a stable connection between the lamp beads and the battery.

In an implementation mode, as shown in FIGS. 1 and 5, bottom covers 4 are provided at bottoms of the battery components 1, and the bottom covers 4 are clamping connected or threaded connected to the battery components 1. In this embodiment, the setting of the bottom covers effectively prevents the battery from falling off. Of course, the above structure is not limited to this and can be any other structure that serves the same purpose.

Working principle: when in use, the sliding part is pushed forward to drive the conductive contact end to slide forward to the contact slots. The conductive contact end is communicated to the battery through the contact slots, the circuit is connected, and the light bead will emit light; the sliding part is pushed to slide backwards, the conductive contact end is driven to slide backwards and slide out of the contact slots, the circuit is disconnected, and the light bead will turn off. The light emitting component is provided with the limiting part, which effectively prevents the conductive contact end from sliding to or out of the contact slots when subjected by an external impact or during transportation. The conductive contact end slides to the connect slots or slide out of the connect slots, it will make a sound during a sliding process of the connect end, thereby it easy for the user to determine whether it has slid in place.

The various technical features of the above embodiments can be combined in any way. In order to render the description concise, not all possible combinations of the various technical features in the above embodiments have been described. However, as long as there is no contradiction in the combination of these technical features, they should be considered within the scope of this specification.

The above embodiments only express several embodiments of the present disclosure, and their descriptions are more specific and detailed, but should not be understood as limiting the scope of the present disclosure. It should be noted that for those skilled in the art, several modifications and improvements can be made without departing from the concept of the present disclosure, which are within the protection scope of the present disclosure. Therefore, the protection scope of the present disclosure should be based on the attached claims.

What is claimed is:

1. A light emitting component, comprising battery components configured to provide electrical energy, a decorative lighting component configured to emit light, and a connecting conductor configured to communicate circuits;
two ends of the decorative lighting component are respectively connected to positive and negative electrodes of the battery components, and the decorative lighting component is communicated to the battery components through the connecting conductor;
there is a gap between the battery components, and the connecting conductor is provided in the gap,
the connecting conductor is capable of sliding in the gap between the battery components.

2. The light emitting component according to claim 1, wherein the battery components comprise a battery box and a battery that are matched with each other,
the battery is provided in the battery box, there are at least two battery boxes, and the gap is provided between the battery boxes.

3. The light emitting component according to claim 2, wherein contact slots are provided on inner side walls of adjacent two battery boxes, and the contact slots and the connecting conductor are matched with each other;
after sliding into the contact slots, the connecting conductor enables the decorative lighting component to communicate with the battery components through the connecting conductor.

4. The light emitting component according to claim 3, wherein the inner side walls of adjacent two battery boxes are provided with limiting parts, and the limiting parts are configured to prevent the connecting conductor from communicating to the battery components without human operation, and the limiting parts and the connecting conductor are matched.

5. The light emitting component according to claim 1, wherein the connecting conductor comprises a sliding part and a conductive contact end, the sliding part and the conductive contact end are fixedly connected,
the sliding part drives the conductive contact end to slide within the gap between the battery components, and the decorative lighting component is communicated to the battery components through the conductive contact end.

6. The light emitting component according to claim 5, wherein the conductive contact end comprises an electric shock end and an extension end, the electric shock end and the extension end are fixedly connected or integrally formed,
the extension end is fixedly connected to the sliding part.

7. The light emitting component according to claim 6, wherein one end of the extension end that is connected to the sliding part is a horizontal connection or a bent arch connection.

8. The light emitting component according to claim 6, wherein the electric shock end is a circular arc shape, a spherical shape, or a hemispherical convex shape.

9. The light emitting component according to claim 8, wherein there are two symmetrical electric shock ends, and the two electric shock ends are fixedly connected or integrally formed.

10. The light emitting component according to claim 9, wherein the electric shock end and the extension end are both made of steel or iron.

11. The light emitting component according to claim 9, wherein the decorative lighting component comprises a lamp bead, a lamp bead positive electrode pin line, and a lamp bead negative electrode pin line,
the lamp bead is connected to positive and negative electrodes of the battery components through the lamp bead positive electrode pin line and the lamp bead negative electrode pin line.

12. The light emitting component according to claim 11, wherein a positive electrode connection port and a negative electrode connection port are provided on the battery components configured to connect the lamp bead positive electrode pin line and the lamp bead negative electrode pin line,
wherein the lamp bead positive electrode pin line is connected to the positive electrode of the battery components through the positive electrode connection port, and the lamp bead negative electrode pin line is connected to the negative electrode of the battery components through the negative electrode connection port.

13. The light emitting component according to claim 12, wherein bottoms of the battery components are provided with bottom covers, the bottom covers are clamping connected or threaded connected to the battery boxes.
